(19) United States
(12) Patent Application Publication
(10) Pub. No.: US 2024/0139941 A1
(43) Pub. Date: May 2, 2024

(54) HANDLING SYSTEM, CONTROL DEVICE, HANDLING METHOD, AND STORAGE MEDIUM

(71) Applicant: Kabushiki Kaisha Toshiba, Tokyo (JP)

(72) Inventors: Harutoshi CHATANI, Yokohama (JP); Kazunobu KONDA, Suginami (JP); Akihito OGAWA, Fujisawa (JP)

(73) Assignee: Kabushiki Kaisha Toshiba, Tokyo (JP)

(21) Appl. No.: 18/496,068

(22) Filed: Oct. 27, 2023

(30) Foreign Application Priority Data
Oct. 31, 2022 (JP) 2022-174808

(51) Int. Cl. B25J 9/16

(52) U.S. Cl. CPC B25J 9/1651; B25J 9/1607; B25J 9/1664

(57) ABSTRACT

According to one embodiment, a handling system includes: a holding unit configured to hold an object; a holding state sensor configured to detect a holding state; a detection unit configured to detect the object and a holding posture; and a control device configured to control an operation of the holding unit. The control device performs: generating a carrying operation plan for allowing the holding unit to carry the object; calculating a safety factor indicating stability of a state in which the holding unit holds the object on the basis of the holding state, the holding posture, and the carrying operation plan; determining whether the carrying operation plan is to be changed on the basis of the safety factor; and changing the carrying operation plan on the basis of the safety factor when it is determined that the carrying operation plan is to be changed.

### CROSS-REFERENCE TO RELATED APPLICATION

This application is based upon and claims the benefit of priority from Japanese Patent Application No. 2022-174808, filed Oct. 31, 2022; the entire contents of (all of) which are incorporated herein by reference.

### FIELD

Embodiments described herein relate generally to a handling system, a control device, a handling method, and a storage medium.

### BACKGROUND

In the related art, a handling device which an end effector holds an object is known. For example, in automation of a carrying operation in a physical distribution site, there is a need to hold objects with various shapes, sizes, and weights and stably to carry the objects. When such objects are carried using such a handling device, an operation plan for stably carrying the objects is determined on the basis of information such as characteristics of the target objects, and the carrying operation is performed. When a change in the information of a target object, a defect of the handling device, or the like occurs, there is a likelihood that the target object will not be able to be stably carried with the planned carrying operation.

### BRIEF DESCRIPTION OF THE DRAWINGS

FIG. 1 is a perspective view schematically illustrating a handling system according to an embodiment.

FIG. 2 is a bottom view of a first holding unit according to the embodiment.

FIG. 3 is a front view and a bottom view of a second holding unit according to the embodiment.

FIG. 4 is a perspective view of the second holding unit according to the embodiment.

FIG. 5 is a block diagram illustrating a configuration of the handling system according to the embodiment.

FIG. 6 is a flowchart illustrating an operation flow in a control device according to the embodiment.

FIG. 7 is a perspective view illustrating an example of shape data according to the embodiment.

FIG. 8 is a top view illustrating an example of the shape data according to the embodiment.

FIG. 9 is a diagram illustrating an example of transit points of the holding unit according to the embodiment.

FIGS. 10A and 10B are diagrams illustrating an example of parameters used to calculate a safety factor according to the embodiment.

FIGS. 11A and 11B are diagrams illustrating an example of a change based on a holding position of parameters used to calculate the safety factor according to the embodiment.

FIGS. 12A and 12B are diagrams illustrating an example of a change based on a holding angle of parameters used to calculate the safety factor according to the embodiment.

FIGS. 13A and 13B are diagrams illustrating an example of a change based on a moving direction of parameters used to calculate the safety factor according to the embodiment.

FIGS. 14A and 14B are diagrams illustrating an example of parameters used to calculate the safety factor according to the embodiment.

FIGS. 15A and 15B are diagrams illustrating an example of a change based on a holding position of parameters used to calculate the safety factor according to the embodiment.

FIGS. 16A and 16B are diagrams illustrating an example of a change based on a holding angle of parameters used to calculate the safety factor according to the embodiment.

FIGS. 17A and 17B are diagrams illustrating an example of a change based on a moving direction of parameters used to calculate the safety factor according to the embodiment.

FIG. 18 is a flowchart illustrating an operation flow of a carrying operation plan determining step and a carrying operation plan correcting step according to the embodiment.

### DETAILED DESCRIPTION

According to one embodiment, a handling system includes: a holding unit configured to hold an object; a holding state sensor attached to the holding unit and configured to detect a holding state in which the holding unit holds the object; a detection unit configured to detect the object and a holding posture in which the holding unit holds the object; and a control device configured to control an operation of the holding unit. The control device performs: generating a carrying operation plan for allowing the holding unit to carry the object; calculating a safety factor indicating stability of a state in which the holding unit holds the object on the basis of the holding state, the holding posture, and the carrying operation plan; determining whether the carrying operation plan is to be changed on the basis of the safety factor; and changing the carrying operation plan on the basis of the safety factor when it is determined that the carrying operation plan is to be changed.

Various Embodiments will be described hereinafter with reference to the accompanying drawings.

Hereinafter, a handling system, a control device, a handling method, and a storage medium according to an embodiment will be described with reference to the accompanying drawings. In the following description, elements having the same or similar functions will be referred to by the same reference signs. Description of the elements will not be repeated. “On the basis of XX” mentioned in this specification means “on the basis of at least XX” and includes “on the basis of another element in addition to XX.” “On the basis of XX” is not limited to direct use of XX and includes use of results obtained by performing calculation or processing on XX. “XX” is an arbitrary factor (for example, arbitrary information).

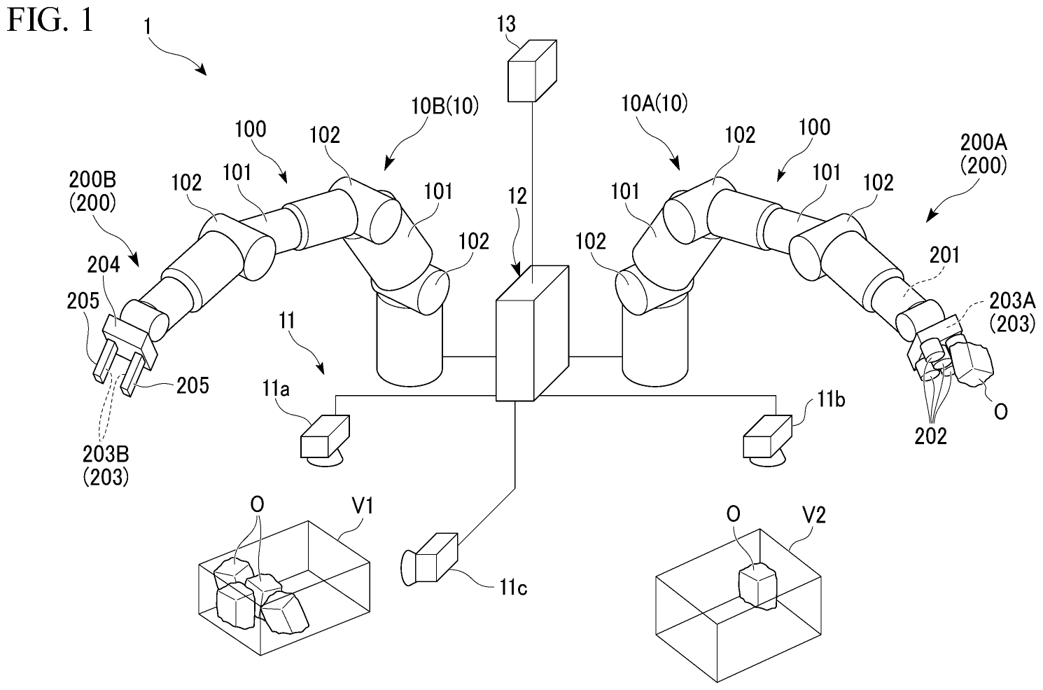

FIG. 1 is a perspective view schematically illustrating a handling system 1 according to the embodiment.

The handling system 1 is, for example, a physical-distribution handling system (a picking system). The handling system 1 carries an object (a holding object or a carrying object) O located in a source container V1 to a destination container V2.

Examples of the source container V1 include various containers such as a conveyor, a pallet, a tote, a collapsible container, and a bin. “Container” broadly refers to a member which can contain an object O (for example, a box-like member). The source container V1 is not limited to the examples.

In the source container V1, various types of objects O with different sizes, weights, and the like are placed randomly. For example, a holding target object O has an uneven shape on at least part of the surface of the object O. In this embodiment, the objects O have various shapes such as a small shape of 5 square cm and a large shape of 30 square cm. The objects O have various weights such as a light weight of several tens of g and a heavy weight of several kg. The sizes, weights, or the like of the objects O are not limited to the examples.

Examples of the destination container V2 include various containers such as a conveyor, a pallet, a tote, a collapsible container, and a bin. Here, the destination container V2 is not limited to these examples. In the following description, the “source container V1” and the “destination container V2” may be simply generically referred to as “containers.” The handling system 1 may carry an object O to a destination container V2 other than a container.

The handling system 1 is not limited to a physical-distribution handling system. The handling system 1 can be widely applied to industrial robot systems or other systems. A “handling system” and a “handling device” mentioned in this specification are not limited to systems or devices for the main purpose of carrying an object and include systems or devices involved in carriage (movement) of an object as part of product assembly or for another purpose.

As illustrated in FIG. 1, the handling system 1 includes a handling device 10, a detection unit 11, a control device 12, and a management device 13. The detection unit 11 or the control device 12 may be assembled into the handling device 10.

The handling device 10 is, for example, a robot device. The handling device 10 holds an object O placed in a source container V1 and moves the held object O to a destination container V2 (a storage area). The handling device 10 can communicate with the control device 12 in a wired or wireless manner. In this embodiment, the handling device 10 includes a first handling device 10A and a second handling device 10B.

The first handling device 10A includes, for example, an arm 100 and a first holding unit 200A provided at the tip of the arm 100.

The arm 100 is a moving mechanism for moving the first holding unit 200A to a desired position. For example, the arm 100 is a six-axis vertical articulated robot arm. The arm 100 can take various positions and postures. Similarly to a human arm or hand, the arm 100 can take various postures for holding an object. The arm 100 includes, for example, a plurality of arm members 101 and a plurality of rotary members 102 rotatably connecting the plurality of arm members 101.

Here, a “holding posture of a hand (a holding unit) when an object is held” represents “a position and a posture (a direction) of a tip of a unified object (hand+held object).” Specifically, when a holding posture is “a position and a posture (a direction) of a tip of a unified object (hand+held object),” the position is coordinates (X, Y, Z) on three axes (X, Y, and Z axes) in a predetermined three-dimensional space coordinate system. The posture is angles (for example, θ, ψ, and ϕ) with respect to the three axes. When the hand (the holding unit) does not hold an object, a position and orientation of the tip of only the hand (the holding unit) are the holding posture of the hand (the holding unit).

The arm 100 may be a three-axis orthogonal robot arm. The arm 100 may be a mechanism for moving the first holding unit 200A to a desired position with other configurations. For example, the arm 100 may be a flying vehicle (for example, a drone) that lifts and moves the first holding unit 200A using rotors.

The first holding unit 200A is a holding mechanism (an end effector) that holds an object O placed in a source container V1. For example, the first holding unit 200A includes a suction device 201, a suction portion 202 communicating with the suction device 201, and a first holding state sensor 203A detecting a holding state when the first holding unit 200A holds an object O. The first holding unit 200A is a suction-type hand that holds an object O by suction.

The suction device 201 is, for example, a vacuum pump. The suction device 201 communicates with a plurality of suction portions 202 via a hose or the like. When the suction device 201 is driven, a pressure in each suction portion 202 becomes lower than atmospheric pressure and an object O is suctioned and held by the suction portions 202.

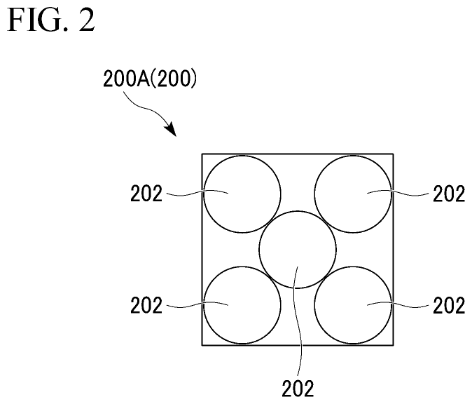

FIG. 2 is a bottom view of the first holding unit 200A illustrating a layout of the suction portions 202 according to the embodiment. In this embodiment, the first holding unit 200A includes five suction portions 202.

The suction portions 202 include one suction portion 202 disposed substantially at the center of the first holding unit 200A and four suction portions 202 disposed around the one suction portion 202 disposed substantially at the center of the first holding unit 200A to correspond to four corners of the first holding unit 200A.

The first holding state sensor 203A is a sensor that is provided in the suction portions 202 or in the vicinity of the suction portions 202 (for example, inside of the first holding unit 200A). The first holding state sensor 203A acquires information of the first holding unit 200A. For example, the first holding state sensor 203A acquires information such as an internal pressure of the suction portions 202, a surface state of the suction portions 202, and an operating state of the suction device 201. The information acquired by the first holding state sensor 203A may include information on a physical state associated with a holding state in which the first holding unit 200A holds an object O. An example of the information on a physical state is a relative positional relationship between the first holding unit 200A and the object O. Examples of the first holding state sensor 203A include one or more physical sensors such as a pressure sensor, a strain sensor, and a proximity or contact sensor. The first holding state sensor 203A may additionally acquire physical information of the object O. For example, the physical information of the object O is information affecting a holding operation of the first holding unit 200A holding the object O such as an outer shape or a deformation of the object O. The first holding state sensor 203A may detect a state of the first holding unit 200A when it does not hold an object O.

The second handling device 10B includes, for example, an arm 100 and a second holding unit 200B provided at the tip of the arm 100. The arm 100 of the second handling device 10B has the same configuration as the arm 100 of the first handling device 10A.

The second holding unit 200B is a holding mechanism (an end effector) that holds an object O placed in a source container V1. For example, the second holding unit 200B includes a connection portion 204, two or more support portions 205 attached to the connection portion 204 to hold an object O, and a second holding state sensor 203B that detects a holding state of the second holding unit 200B when it holds an object O. The second holding unit 200B is a pinch-type hand pinching and holding an object O with two fingers (the support portions 205) and is provided at the tip of the arm 100. The configuration of the second holding unit 200B is not limited thereto and may be, for example, a pinch-type hand pinching and holding an object O with three or four fingers.

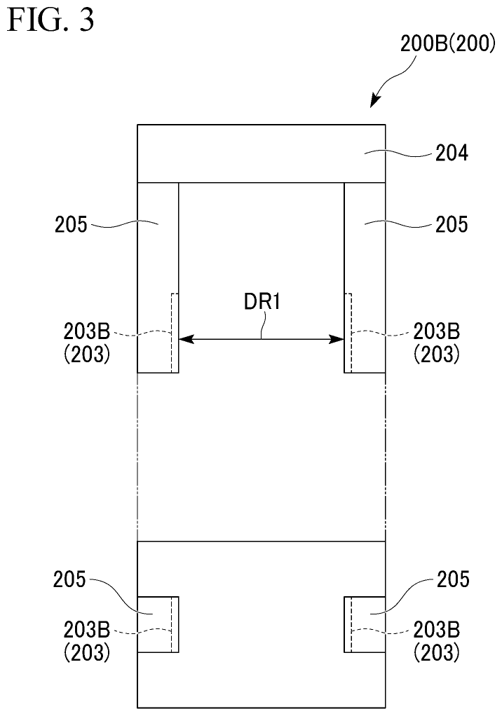

FIG. 3 is a front view and a bottom view of the second holding unit 200B. The front view of the second holding unit 200B is illustrated in the upper part of FIGS. 3, and the bottom view of the second holding unit 200B is illustrated in the lower part of FIG. 3. In this embodiment, the second holding unit 200B includes two support portions 205.

The connection portion 204 is a base of the second holding unit 200B and connects the arm 100 and the support portions 205. The connection portion 204 includes a structure for causing the two support portions 205 to come close to or move away from each other. A link mechanism for causing the two support portions 205 to come close to or move away from each other may be additionally provided between the connection portion 204 and the support portions 205.

Each support portion 205 is a rod-shaped finger or nail having a base connected to the connection portion 204. As illustrated in FIG. 3, two support portions 205 move away from each other in a direction DR1. A distance between the two support portions 205 in the direction DR1 is variable.

The second holding state sensor 203B is a sensor that is provided in the support portions 205 or in the vicinity of the support portions 205 (for example, inside of the second holding unit 200B). The second holding state sensor 203B acquires information of the second holding unit 200B. For example, the second holding state sensor 203B acquires information such as a deformation or a surface state of the support portions 205 and a force applied to the support portions 205. The information acquired by the second holding state sensor 203B may include information on a physical state associated with a holding state in which the second holding unit 200B holds an object O. An example of the information on a physical state is a relative positional relationship between the second holding unit 200B and the object O. Examples of the second holding state sensor 203B include one or more physical sensors such as a pressure sensor, a strain sensor, and a proximity or contact sensor. The second holding state sensor 203B may additionally acquire physical information of the object O. For example, the physical information of the object O is information affecting a holding operation of the second holding unit 200B holding the object O such as an outer shape or a deformation of the object O. The second holding state sensor 203B may detect a state of the second holding unit 200B when it does not hold an object O.

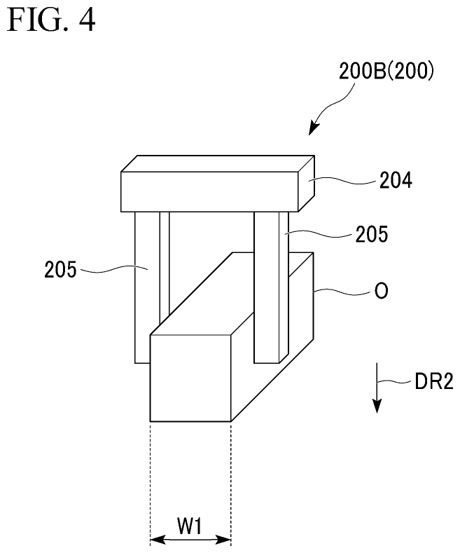

FIG. 4 is a perspective view of a state in which the second holding unit 200B holds an object O.

The second holding unit 200B moves in a moving direction DR2 in a state in which a distance between two support portions 205 in the direction DR1 is kept larger than a width W1 of an object O and moves to a position at which the object O is disposed between the two support portions 205. Thereafter, the second holding unit 200B pinches the object O with the two support portions 205 by reducing the distance between the two support portions 205 in the direction DR1 and bringing the two support portions 205 into contact with the object O.

In the following description, the “first holding unit 200A” and the “second holding unit 200B” may be simply generically referred to as “holding units 200.” The “first holding state sensor 203A” and the “second holding state sensor 203B” may be simply generically referred to as “holding state sensors 203.”

The detection unit 11 includes a source sensor 11a, a destination sensor 11b, and a posture estimation sensor 11c. The source sensor 11a, the destination sensor 11b, and the posture estimation sensor 11c are connected to the control device 12 in a wired or wireless manner.

The source sensor 11a is a camera or various types of sensors disposed in the vicinity of a source container V1 (for example, just above or obliquely above the source container V1). The source sensor 11a acquires, for example, information on an object O placed in the source container V1 and information on the source container V1. The information acquired by the source sensor 11a is, for example, “image data,” “range image data,” and “shape data.”

“Range image data” is image data including distance information in one or more directions (for example, depth information from an arbitrary reference plane set above the source container V1). “Shape data” is information indicating an outer shape or the like of the object O. The information detected by the source sensor 11a is output to the control device 12. The source sensor 11a may be provided as part of the handling device 10.

The destination sensor 11b is a camera or various types of sensors disposed in the vicinity of a destination container V2 (for example, just above or obliquely above the destination container V2). The destination sensor 11b detects, for example, information on a shape of the destination container V2 (including a shape of an inner wall surface or a partition) and information on an object O placed already in the destination container V2.

The information acquired by the destination sensor 11b is, for example, “image data,” “range image data,” and “shape data.” The information detected by the destination sensor 11b is output to the control device 12. The destination sensor 11b may be provided as part of the handling device 10.

The posture estimation sensor 11c is a camera or various types of sensors disposed in the vicinity of the source container V1 (for example, just above or obliquely above the source container V1). The posture estimation sensor 11c detects, for example, information on a holding posture of the holding unit 200 holding the object O. The information acquired by the posture estimation sensor 11c is, for example, “image data,” “range image data,” “shape data,” and “holding posture data.” “Holding posture data” is data indicating a positional relationship or the like between the holding unit 200 and the object O held by the holding unit 200.

The control device 12 performs management and control of the handling system 1 as a whole. For example, the control device 12 acquires information detected by the source sensor 11a, the destination sensor 11b, and the posture estimation sensor 11c and controls the handling device 10 on the basis of the acquired information. The control device 12 is, for example, a device (a computer) that can execute a program and that includes a processor, a memory, and a storage unit.

All or some of functions of the control device 12 are realized, for example, by causing one or more processors such as a central processing unit (CPU) or a graphics processing unit (GPU) to execute a program stored in a program memory.

All or some of these functions may be realized by hardware (for example, a circuit unit: circuitry) such as a large-scale integration (LSI), an application-specific integrated circuit (ASIC), a field-programmable gate array (FPGA), or a programmable logic device (PLD).

All or some of these functions may be cooperatively realized by software and hardware. The storage unit is realized by a flash memory, an electrically erasable programmable read-only memory (EEPROM), a read-only memory (ROM), a random access memory (RAM), or the like.

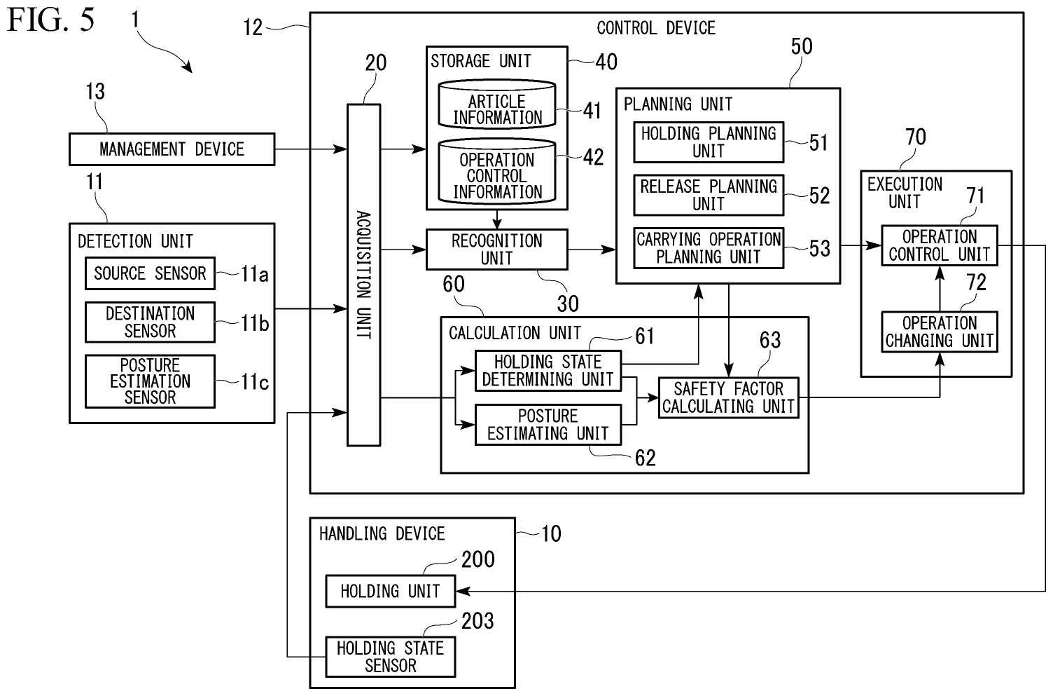

FIG. 5 is a block diagram illustrating a configuration of the handling system 1.

As illustrated in FIG. 5, the control device 12 includes an acquisition unit 20, a recognition unit 30, a storage unit 40, a planning unit 50, a calculation unit 60, and an execution unit 70.

The acquisition unit 20 acquires information output from the detection unit 11, the management device 13, or the holding state sensor 203. The recognition unit 30 performs image processing or the like on information such as image data output from the acquisition unit 20. The control device 12 acquires article information 41 and operation control information 42 from a host system such as the management device 13. The control device 12 may generate the operation control information 42 by itself. The acquired article information 41 and the acquired operation control information 42 are stored in the storage unit 40 and output to the recognition unit 30. The article information 41 is information such as a shape, a weight, and a gravitational center position of an object O designated in a picking list.

The operation control information 42 is operation control information for allowing the holding unit 200 to carry (move) an object O designated in the picking list. The operation control information 42 is control information on a carrying speed or a carrying acceleration which is predetermined before the holding unit 200 holds and moves the object O. The operation control information 42 includes one or more pieces of information of a speed or acceleration of the holding unit 200, an acceleration/deceleration pattern such as trapezoidal acceleration or S-shaped acceleration, an acceleration/deceleration section pattern indicating an acceleration/deceleration for each carrying section, a maximum carrying speed or a maximum carrying acceleration for each object, and a speed or acceleration for each transit point. The maximum carrying speed and the maximum carrying acceleration for each object may be included in the article information 41.

The maximum carrying speed and the maximum carrying acceleration are determined for each object O to be carried. In this embodiment, the maximum carrying speed and the maximum carrying acceleration are determined on the basis of a state of an object O to be carried and can be set according to a type of the object O by classifying objects O into product types or the like. For example, the types of objects O include various types such as a flexible object which an outer shape is easily deformed, a hard object which an outer shape is not easily deformed, an object having a flat surface, and an object with much uneven surface. Accordingly, the objects can be classified into the types, and the maximum carrying speed and the maximum carrying acceleration can be set for each classified type. For example, flags can be assigned to the classified types of the objects O and settings of the maximum carrying speed and the maximum carrying acceleration based on each flag can be used.

The same type of objects such as the same type of products may vary in state thereof according to workmanship or the like due to manufacturing unevenness, and a difference in state between the objects O affects a holding operation for causing the holding unit 200 to hold the objects O. Accordingly, regarding even the same type of objects, the maximum carrying speed and the maximum carrying acceleration may be set for each individual object.

The planning unit 50 acquires operation plans such as a holding operation plan for allowing the holding unit 200 to hold an object O and a carrying operation plan for carrying the object O. The planning unit 50 may generate the operation plans on the basis of information acquired from the recognition unit 30 or the calculation unit 60 or may acquire the operation plans from a host system such as the management device 13.

The calculation unit 60 performs evaluation of a holding state, calculation of a safety factor ratio indicating stability of the holding state, and the like on the basis of information acquired from the acquisition unit 20 or the planning unit 50. The execution unit 70 controls the handling device 10 on the basis of information output from the planning unit 50 or the calculation unit 60. Here, stability of a holding state indicates a likelihood that an object O will drop from the holding unit 200 (a degree of risk of dropping) when the holding unit 200 is carrying the object O. The stability becomes higher as the safety factor ratio becomes higher, and the stability becomes lower as the safety factor ratio becomes lower. For example, the handling device 10 may be controlled such that the acceleration for carrying the object O increases when the safety factor ratio is equal to or greater than a predetermined value, and the handling device 10 may be controlled to curb dropping of the object O such that the acceleration for carrying the object O decreases when the safety factor ratio is equal to or less than the predetermined value.

The management device 13 manages a picking list (for example, the types or the number of objects O to be picked), an inventory situation of objects O, and the like. For example, the management device 13 can receive a picking list from a user and transmit the received picking list to the handling device 10 or the control device 12. The management device 13 may transmit the operation control information 42 for each object to be picked to the control device 12.

Operations of the handling system 1 will be described below.

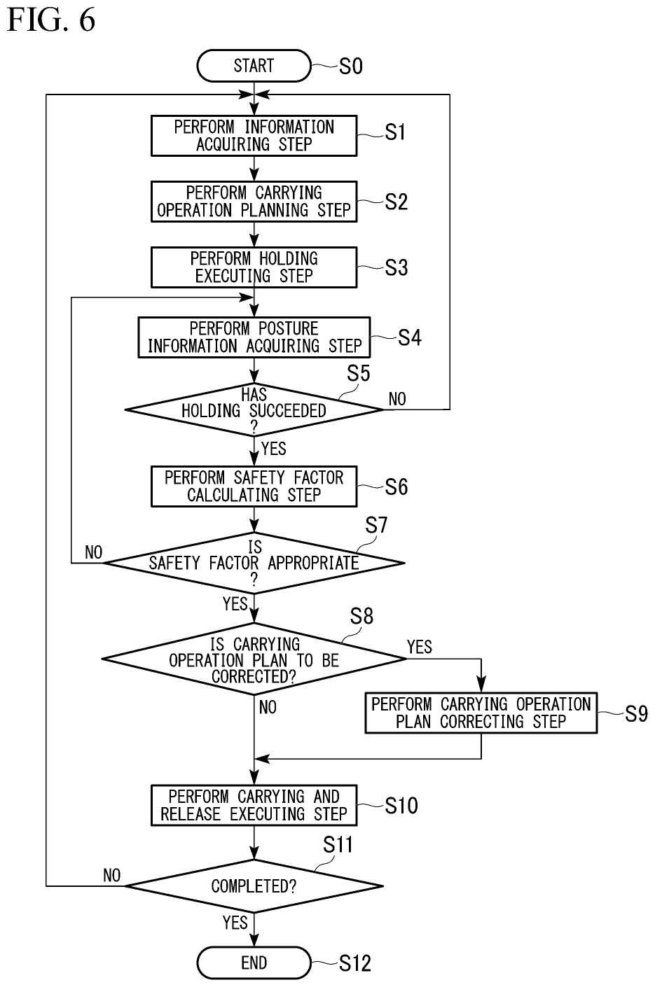

FIG. 6 is a flowchart illustrating a flow of operations which are performed by the control device 12 according to the embodiment. The operations of the handling system 1 will be described with reference to FIGS. 5 and 6.

When the control device 12 is started, the control device 12 starts control of the handling device 10 after having performed initialization of the handling device 10 or the detection unit 11 (Step S0).

Then, the control device 12 performs Step S1 (an information acquiring step).

In Step S1, the control device 12 acquires information from the management device 13, the detection unit 11, and the like. The acquisition unit 20 acquires a picking list from the management device 13. The acquisition unit 20 acquires image data, range image data, and shape data of objects O in a source container V1, image data, range image data, and shape data of a destination container V2, and the like using a source sensor 11a and a destination sensor 11b.

The recognition unit 30 determines whether an object O in the picking list is placed in the source container V1. The recognition unit 30 acquires the article information 41 and the operation control information 42.

The recognition unit 30 generates information to be output to the planning unit 50, for example, by performing image processing on the image data acquired by the acquisition unit 20.

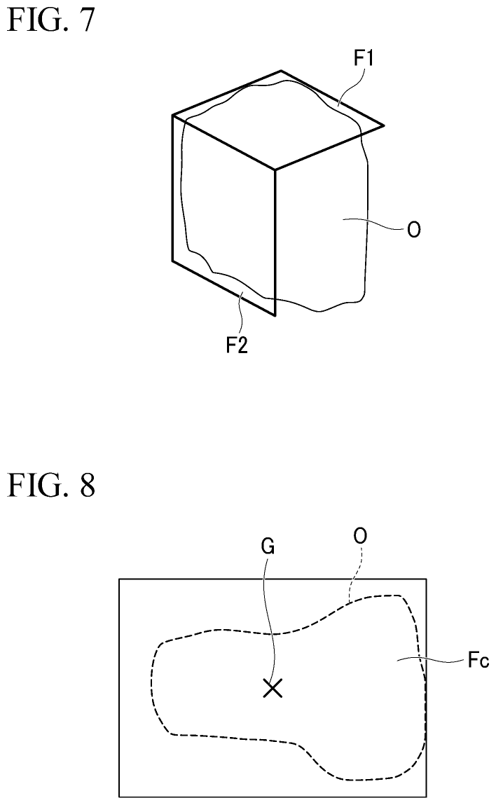

FIG. 7 is a perspective view illustrating an example of shape data according to the embodiment. Information generated by the recognition unit 30 includes, for example, information on a first surface F1 and a second surface F2 adjacent to the first surface F1 in a rectangular parallelepiped shape circumscribing an object O. For example, when the surface of the object O is non-flat (when the surface of the object O has an uneven shape), the recognition unit 30 recognizes a rectangular parallelepiped shape circumscribing an outermost protruding portion of the surface of the object O as outer shape information of the object O.

FIG. 8 is a top view illustrating an example of shape data according to the embodiment. For example, the recognition unit 30 recognizes an outer shape when an object O is seen in a specific direction as a holdable area Fc of the object O. The holdable area Fc is a flat portion which can be suctioned or pinched on the surface of the object O. The recognition unit 30 may recognize a position of the center of gravity G of the object O.

Then, the control device 12 performs Step S2 (a carrying operation planning step).

In Step S2, a holding planning unit 51 of the planning unit 50 acquires a holding operation plan for allowing the holding unit 200 to hold the object O on the basis of the operation control information 42. A release planning unit 52 of the planning unit 50 acquires a release operation plan for allowing the holding unit 200 to release the object O in the destination container V2 on the basis of the operation control information 42. A carrying operation planning unit 53 acquires a carrying operation plan for allowing the holding unit 200 to carry the object O on the basis of the operation control information 42. The planning unit 50 outputs the acquired holding operation plan, the acquired release operation plan, and the acquired carrying operation plan to the execution unit 70. The planning unit 50 may output the operation control information 42 acquired from the host system such as the management device 13 to the execution unit 70.

Then, the control device 12 performs Step S3 (a holding executing step).

In Step S3, an operation control unit 71 of the execution unit 70 controls the handling device 10 on the basis of the holding operation plan such that the holding unit 200 holds the object O. The operation control unit 71 of the execution unit 70 may control the handling device 10 on the basis of the operation control information 42.

After the holding unit 200 has held the object O, the acquisition unit 20 acquires information on a physical state of the holding unit 200 or the object O from the holding state sensor 203 of the handling device 10. Here, information on the physical state of the object O is, for example, information affecting the holding operation of the holding unit 200 holding the object O such as an outer shape or a deformation of the object O. A holding state determining unit 61 of the calculation unit 60 acquires a holding state in which the holding unit 200 holds the object O on the basis of the information acquired from the holding state sensor 203 and determines whether the holding unit 200 holds the object O as instructed by the execution unit 70. For example, the holding state determining unit 61 acquires a suction force of the suction portions 202 from the holding state sensor 203 and determines the holding state by comparing the acquired suction force with a suction force instructed from the execution unit 70 to the handling device 10.

The control device 12 may update the carrying operation plan on the basis of the information (the holding state) acquired from the holding state sensor 203.

Then, the control device 12 performs Step S4 (a posture information acquiring step).

In Step S4, the holding unit 200 moves to a position at which information on a holding posture (posture information) of the object O in the holding unit 200 during carrying the object can be acquired by the posture estimation sensor 11c. The acquisition unit 20 acquires the posture information detected by the posture estimation sensor 11c.

Then, the control device 12 performs Step S5 (a posture information determining step).

In Step S5, a posture estimating unit 62 determines whether the holding unit 200 holds the object O on the basis of the detected posture information. For example, when height information of the object O in the posture information acquired by the posture estimating unit 62 indicates 0, it is determined that holding of the object O fails. At this time, there is a likelihood that the position of the object O in the source container V1 changes due to failure of the holding. Accordingly, when holding of the object O fails, the control device 12 returns the operation flow to Step S1 and re-acquires information of the object O placed in the source container V1.

When it is determined in Step S5 that holding of the object succeeds, the control device 12 performs Step S6 (a safety factor calculating step).

In Step S6, the posture estimating unit 62 calculates a holding posture in which the holding unit 200 holds the object O on the basis of the posture information acquired in Step S4. A safety factor calculating unit 63 calculates a safety factor ratio on the basis of the holding posture calculated by the posture estimating unit 62, the holding state acquired by the holding state determining unit 61 in Step S4, and the carrying operation plan.

Details of the method of calculating the safety factor ratio will be described later.

The safety factor calculating unit 63 calculates a safety factor ratio based on the carrying operation plan (a planned safety factor) and a safety factor ratio based on the detected holding state and the holding posture (a detected safety factor). The safety factor calculating unit 63 outputs the planned safety factor and the detected safety factor to an operation changing unit 72.

Then, the control device 12 performs Step S7 (a safety factor calculation determining step).

In Step S7, the operation changing unit 72 determines whether the detected safety factor has been appropriately calculated in Step S6. When the detected safety factor has not been appropriately calculated, the control device 12 returns the operation flow to Step S4 and re-acquires the posture information.

When it is determined in Step S7 that the detected safety factor has been appropriately calculated, the control device 12 performs Step S8 (a carrying operation plan determining step). In Step S8, the execution unit 70 compares the planned safety factor and the detected safety factor and determines whether the carrying operation plan needs to be corrected.

When the carrying operation plan needs to be corrected, the control device 12 performs Step S9 (a carrying operation plan correcting step). In Step S9, the execution unit 70 corrects the carrying operation plan on the basis of the safety factor ratio. When the carrying operation plan does not need to be corrected, Step S9 is skipped. Details of correction of the carrying operation plan will be described later.

Then, the control device 12 performs Step S10 (a carrying and release executing step).

In Step S10, the execution unit 70 controls the handling device 10 on the basis of the carrying operation plan such that the handling device 10 carries the object O. At this time, when the carrying operation plan has been corrected in Step S9, the execution unit 70 controls the handling device 10 on the basis of the corrected carrying operation plan. The execution unit 70 releases the object O in the destination container V2 on the basis of the release operation plan.

Then, the control device 12 performs Step S11 (a carrying completion determining step).

In Step S11, the control device 12 determines whether carrying of the objects O corresponding to the number designated in the picking list has been completed. When carrying of the objects O corresponding to the number designated in the picking list has not been completed, the control device 12 performs Step S1 again. When carrying of the objects O corresponding to the number designated in the picking list has been completed, the control device 12 performs Step S12 to end this control.

In this way, the handing method performed by the handling system 1 according to the embodiment includes an information acquiring step of detecting an object O, a source container V1, a destination container V2, a holding state, and a holding posture using the detection unit 11 and the holding state sensor 203, a planning step of acquiring a carrying operation plan from the acquired information and the operation control information 42, a plan correcting step of calculating a safety factor ratio on the basis of the holding state and the holding posture and correcting the carrying operation plan on the basis of the calculated safety factor ratio, and an execution step of carrying the object O on the basis of the corrected carrying operation plan.

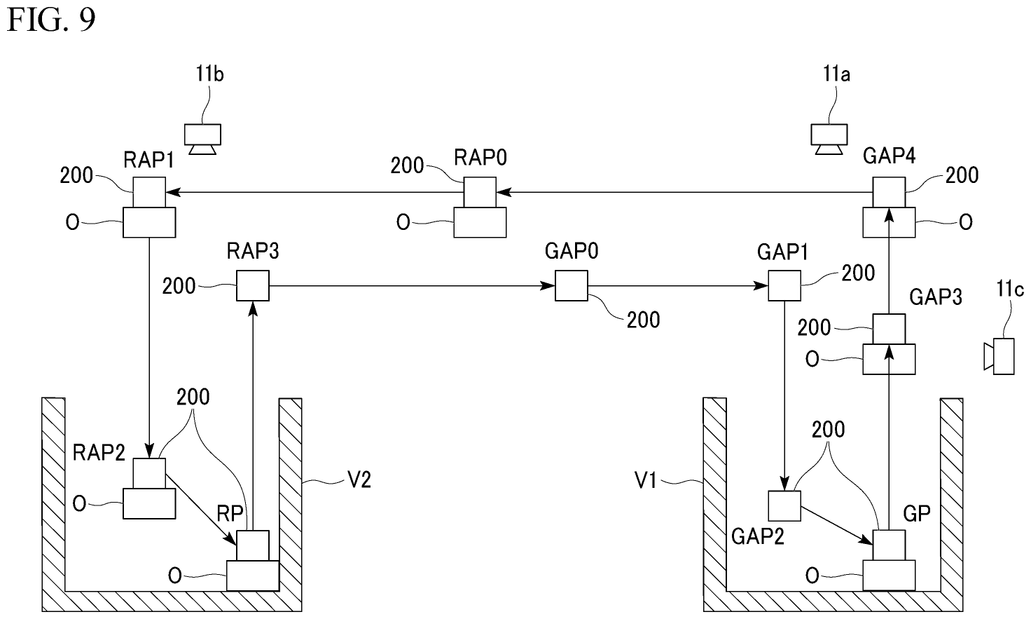

FIG. 9 is a diagram illustrating an example of transit points of the holding unit 200 according to the embodiment. An example of transit points of the holding unit 200 will be described below with reference to FIG. 9.

A transit point GAP0 is an initial position of the holding unit 200. A transit point GAP1 is a transit point at which the holding unit 200 not holding an object O is located just above the source container V1. A transit point GAP2 is a transit point which is sufficiently close to an object O to be held. A transit point GP is a transit point which is set as a target position immediately before the holding unit 200 holds the object O.

The holding unit 200 holding the object O moves to a transit point GAP3. The transit point GAP3 is a transit point when the holding unit 200 holds the object O and departs from the source container V1. In FIG. 9, the posture estimation sensor 11c detects the holding posture of the holding unit 200 departing from the source container V1. The posture estimation sensor 11c may detect a holding posture of the source container V1. A transit point GAP4 is a transit point at which movement to the destination container V2 starts after the holding unit 200 has departed from the source container V1.

A transit point RAP0 is a transit point on the way in which the holding unit 200 holding the object O is moving from the source container V1 to the destination container V2. A transit point RAP1 is a transit point at which the holding unit 200 holding the object O is located above the destination container V2. A transit point RAP2 is a transit point which is sufficiently close to a position at which the holding unit 200 releases the object O in the destination container V2.

A transit point RP is a transit point set as a target position at which the holding unit 200 releases the object O. The holding unit 200 moves to a transit point RAP3 after having released the object O. The transit point RAP3 is a transit point at which movement to the transit point GAP0 which is an initial position starts after the holding unit 200 has departed from the destination container V2. The holding unit 200 returns to the transit point GAP0 which is an initial position via the transit point RAP3.

The transit points of the holding unit 200 illustrated in FIG. 9 are, for example, points (positions) at which the holding unit 200 performs necessary operations according to the operation plans and indicates a start point or an end point of a section in which the holding unit 200 performs operations of carrying the object O or the like. A line connecting the transit points is a carrying route of the object O, and the carrying route of the object O is changed by changing the transit points. For example, first, transit points are set and a carrying route is formed by the set transit points. Each transit point indicates a position or a posture of the holding unit 200 and is a start point or an end point of an operation of the holding unit 200. For example, the handling device 10 is controlled such that a holding operation is started when the holding unit reaches a certain transit point, and the position or posture of the handling device 10 at a time point at which the holding operation has been completed can be expressed as another transit point.

A detailed method of calculating a safety factor ratio in Step S6 will be described below. First, the method of calculating the safety factor ratio in the holding unit 200A (a suction-type hand) will be described.

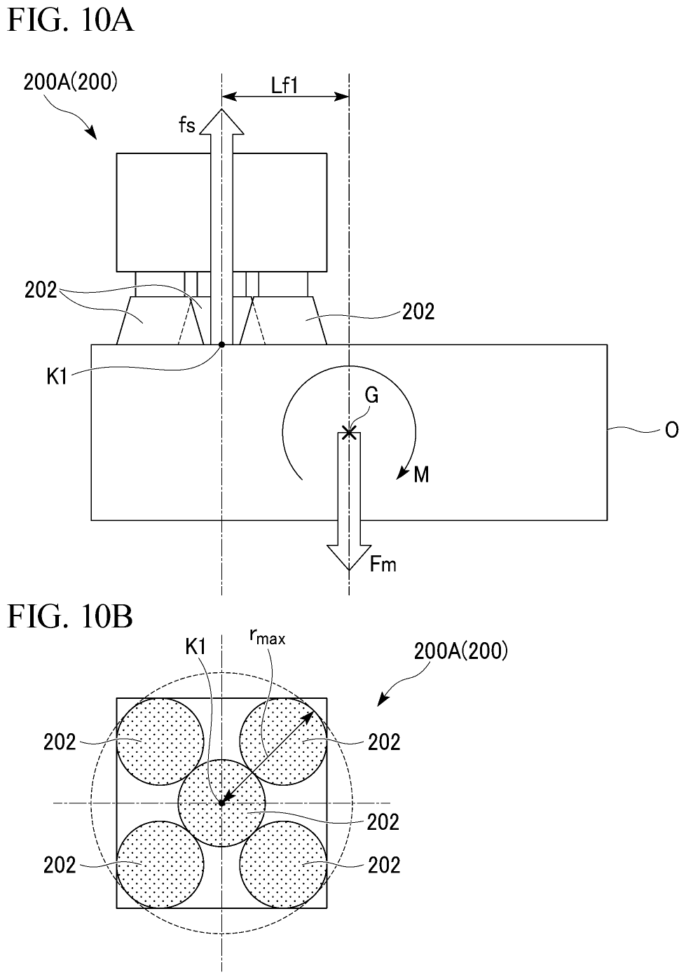

FIGS. 10A and 10B are diagrams illustrating parameters used to calculate the safety factor ratio in the first holding unit 200A. FIG. 10A is a side view when the first holding unit 200A holds (attracts by suction) an object O from upward in the vertical direction. FIG. 10B is a bottom view of the first holding unit 200A in FIG. 10A. At this time, all the suction portions 202 out of five suction units 202 attract the object O by suction, and the holding state (the suction state) thereof is detected by the first holding state sensor 203A. The first holding unit 200A stops.

The safety factor ratio in the first holding unit 200A is expressed as a ratio of a holding force fₛ with which the first holding unit 200A holds an object O to a maximum stress σₘₐₓ applied from the object O to the first holding unit 200A as expressed by Expression 1.

$$\\ \begin{matrix}ratio = \frac{{f}_{s}}{{σ}_{max}} & Expression 1\end{matrix}$$

The holding force fₛ with which the first holding unit 200A holds an object O is, for example, a suction force of the suction device 201. The maximum stress σₘₐₓ applied from the object O to the first holding unit 200A is expressed by Expression 2.

$$\\ \begin{matrix}{σ}_{max} = \frac{{F}_{m}}{A} + M \frac{{r}_{max}}{I} & Expression 2\end{matrix}$$

In Expression 2, Fₘ is a force applied to the object O and is expressed by Expression 3 using a mass m of the object O and acceleration a applied to the object O. When the first holding unit 200A stops, the gravitational acceleration g applied to the center of gravity G of the object O is used as the acceleration a.

Fₘ=ma Expression 3

A is a contact area between the first holding unit 200A and the object O. K1 in FIG. 10A is the center of a contact surface (a contact surface center) on which the first holding unit 200A comes into contact with the object O. L_{f}1 is a distance from the contact surface center K1 to the center of gravity G of the object O.

In Expression 2, M is a bending moment applied to the contact surface center K1 of the first holding unit 200A from the object O and is expressed by Expression 4 using the force Fₘ applied to the object O and the distance L_{f}1.

M=FₘL_{f}1 Expression 4

In Expression 2, rₘₐₓ is a distance (a radius) from the contact surface center K1 to an outermost circumference of the suction portions 202 attracting the object O by suction (an effective suction portion).

FIGS. 11A and 11B are diagrams illustrating an example of change based on a holding position of parameters used to calculate the safety factor ratio in the first holding unit 200A. FIG. 11A is a side view of the first holding unit 200A holding an object O using two suction portions 202 far from the center of gravity G of the object O. FIG. 11B is a bottom view of the first holding unit 200A in FIG. 11A and illustrates the suction portions 202 (effective suction portions) attracting the object O.

The position of the contact surface center K1 in FIGS. 11A and 11B is farther from the center of gravity G of the object O than the position in FIGS. 10A and 10B. Accordingly, the distance L_{f}1 of the holding posture in FIGS. 11A and 11B has a larger value than that of the holding posture in FIGS. 10A and 10B. The suction portions 202 (effective suction portions) attracting the object O by suction in FIGS. 11A and 11B are two suction portions 202 disposed at positions far from the center of gravity G of the object O. Accordingly, as illustrated in FIG. 11B, the radius rₘₐₓ of the holding posture in FIGS. 11A and 11B has a smaller value than that of the holding posture in FIGS. 10A and 10B.

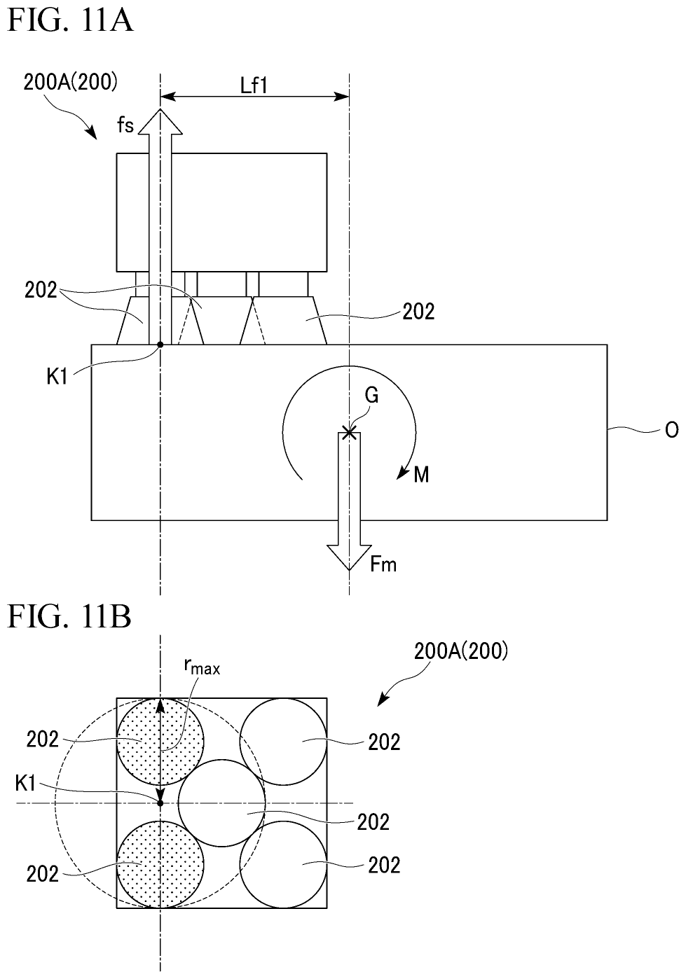

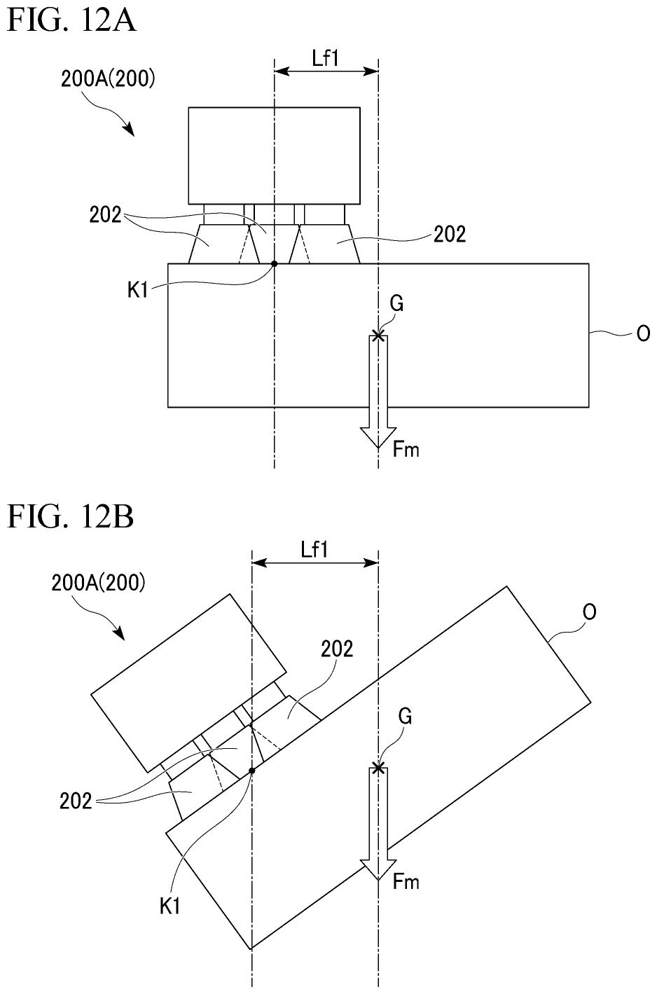

FIGS. 12A and 12B are diagrams illustrating an example of change based on a holding angle of parameters used to calculate the safety factor ratio in the first holding unit 200A. Similarly to FIG. 10A, FIG. 12A is a diagram illustrating the first holding unit 200A when the first holding unit 200A holds an object O from upward in the vertical direction using five suction portions 202. FIG. 12B is a diagram illustrating a state in which the first holding unit 200A holds an object O obliquely in the horizontal direction. The distance L_{f}1 of the holding posture in FIG. 12B is larger than that in FIG. 12A.

As illustrated in FIGS. 11A and 11B and FIGS. 12A and 12B, the distance L_{f}1 and the radius rₘₐₓ depend on the holding posture.

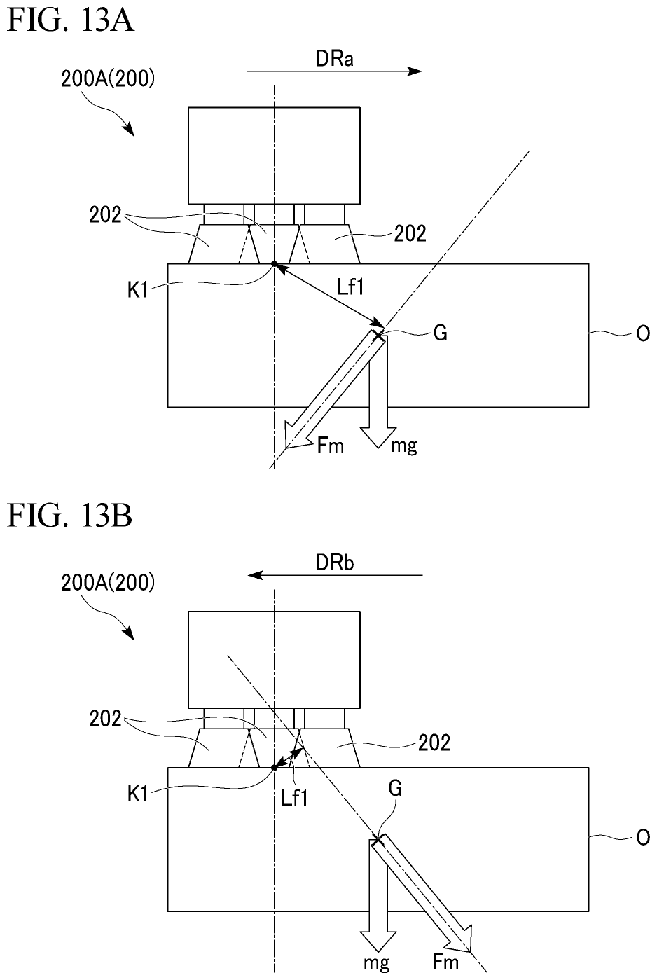

FIGS. 13A and 13B are diagrams illustrating an example of change based on a moving direction of parameters used to calculate the safety factor ratio in the first holding unit 200A. FIG. 13A is a diagram illustrating the first holding unit 200A carrying an object O in a moving direction DRa. FIG. 13B is a diagram illustrating the first holding unit 200A carrying an object O in a moving direction DRb.

A force mg based on the gravitational acceleration g is applied to the center of gravity G of the object O in FIGS. 13A and 13B downward in the vertical direction. An inertial force is applied in the opposite directions of the moving directions DRa and DRb. At this time, the force Fₘ applied to the center of gravity G of the object O is a combined force of the force mg based on the gravitational acceleration g and the inertial force. When the holding posture and the acceleration of the first holding unit 200A are the same in FIGS. 13A and 13B, the distance L_{f}1 in the moving direction in FIG. 13A is larger than the distance L_{f}1 in FIG. 13B.

As illustrated in FIGS. 13A and 13B, the distance L_{f}1 depends on the moving direction of the first holding unit 200A.

In Expression 2, I is a sectional moment of inertia with a contact surface between the first holding unit 200A and the object O as a sectional surface. The sectional moment of inertia I varies according to a sectional shape of the contact surface between the first holding unit 200A and the object O. For example, a sectional moment of inertia of a circular section I_{c} is expressed by Expression 5 and depends on a radius r_{c} of the circular section.

$$\\ \begin{matrix}{I}_{C} = \frac{π {r}_{c}^{{}^{} 4}}{4} & Expression 5\end{matrix}$$

The method of calculating the safety factor ratio in the second holding unit 200B (a pinch-type hand) will be described below.

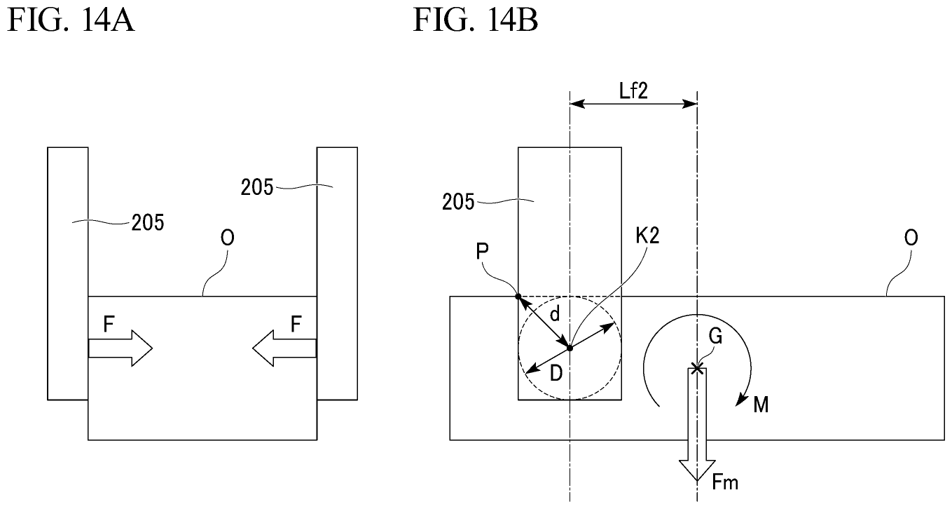

FIGS. 14A and 14B are diagrams illustrating parameters used to calculate the safety factor ratio in the second holding unit 200B. FIG. 14A is a front view when the second holding unit 200B holds (pinches) an object O in the horizontal direction. FIG. 14B is a side view of FIG. 14A. At this time, the second holding unit 200B stops.

As expressed by Expression 6, the safety factor ratio in the second holding unit 200B is expressed as a ratio of a holding force fₚ with which the second holding unit 200B holds the object O to a maximum stress σₘₐₓ applied from the object O to the second holding unit 200B.

$$\\ \begin{matrix}ratio = \frac{{f}_{p}}{{σ}_{max}} & Expression 6\end{matrix}$$

In Expression 6, the holding force fₚ with which the second holding unit 200B holds the object O is a frictional pressure based on a frictional force generated on the contact surface between the support portions 205 and the object O due to a force (a grasping force F) applied from the support portions 205 to the object O and is expressed by Expression 7. The grasping force F is detected by the second holding state sensor 203B.

$$\\ \begin{matrix}{f}_{p} = \frac{2 μ F}{A} & Expression 7\end{matrix}$$

In Expression 7, A is a contact area between the support portions 205 and the object O. Here, μ is a static frictional coefficient.

The maximum stress σₘₐₓ applied from the object O to the second holding unit 200B is expressed by Expression 8.

$$\\ \begin{matrix}{σ}_{max} = \frac{{F}_{m}}{A} + M \frac{d}{2 {I}_{p}} & Expression 8\end{matrix}$$

In Expression 8, the force Fₘ applied to the object O is expressed by Expression 3, similarly to calculation of the safety factor ratio in the first holding unit 200A.

K2 in FIG. 14B is the center of a contact surface (a contact surface center) on which the support portions 205 come into contact with the object O. L_{f}2 is a distance from the contact surface center K2 to the center of gravity G of the object O.

In Expression 8, M is a bending moment applied to the contact surface center K2 of the second holding unit 200B from the object O and is expressed by Expression 9 using the force Fₘ applied to the object O and the distance L_{f}2.

M=FₘL_{f}² Expression 9

In Expression 8, d is a distance from a point (a dangerous position P) farthest from the center of gravity G of the object O to the contact surface center K2 on the contact surface between the support portions 205 and the object O. Iₚ is a sectional moment of inertia of an approximate circle when the contact surface between the support portion 205 and the object O is approximated to a circle and is expressed by Expression 10.

$$\\ \begin{matrix}{I}_{p} = \frac{π {D}^{{}^{} 4}}{32} & Expression 10\end{matrix}$$

In Expression 10, D is a diameter of an approximate circle when the contact surface between the support portion 205 and the object O is approximated to a circle.

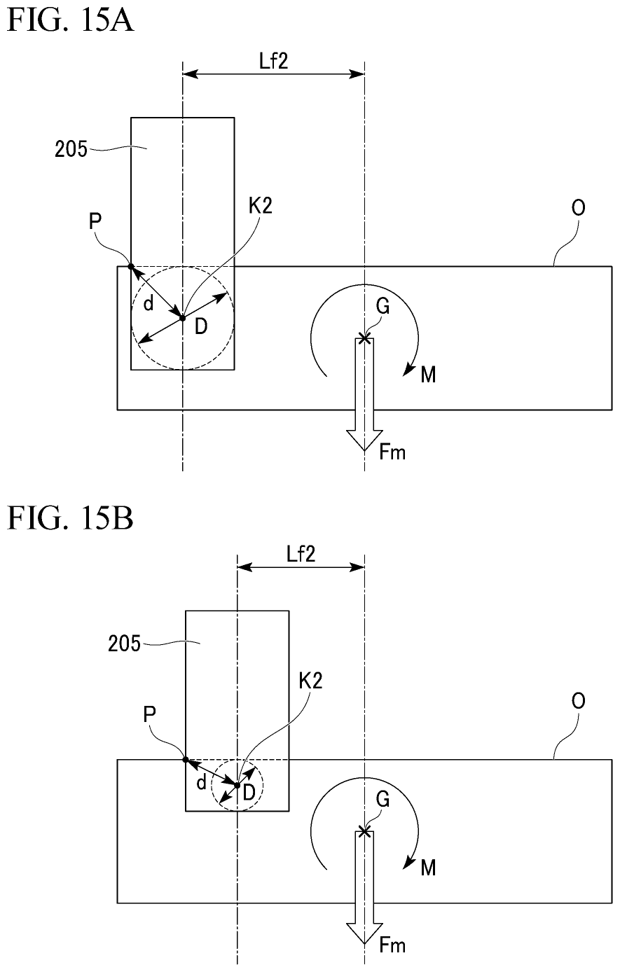

FIGS. 15A and 15B are diagrams illustrating an example of change based on a holding position of parameters used to calculate the safety factor ratio in the second holding unit 200B. FIG. 15A is a diagram illustrating a holding posture in which a position of the object O farther from the center of gravity G than that in FIG. 14B is held with the support portion 205. FIG. 15B is a diagram illustrating a holding posture in which the contact area between the support portion 205 and the object O is smaller than that in FIG. 14B. In comparison with the holding posture illustrated in FIG. 14B, the distance L_{f}2 in FIG. 15A is larger and the diameter D and the distance d in FIG. 15B are smaller.

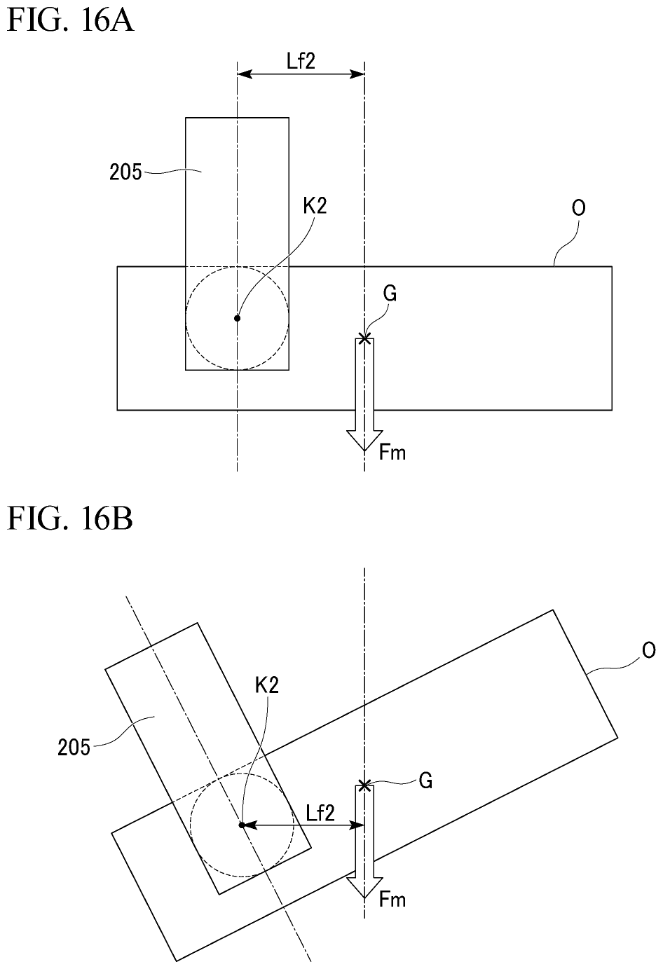

FIGS. 16A and 16B are diagrams illustrating an example of change based on a holding angle of parameters used to calculate the safety factor ratio in the second holding unit 200B. FIG. 16A is a side view when the second holding unit 200B holds (pinches) the object O in the horizontal direction similarly to FIGS. 14A and 14B. FIG. 16B is a diagram illustrating a state in which the second holding unit 200B holds the object O obliquely in the horizontal direction. The distance L_{f}2 in the holding posture illustrated in FIG. 16B is smaller than that in FIG. 16A.

As illustrated in FIGS. 15A and 15B and FIG. 16A and 16B, the distance L_{f}2, the diameter D, and the distance d depend on the holding posture.

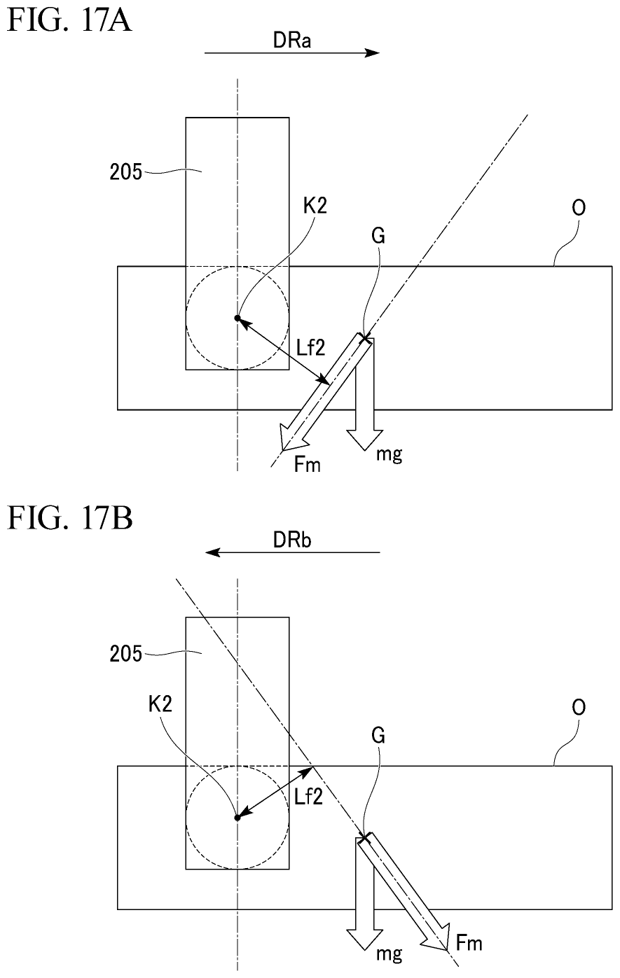

FIGS. 17A and 17B are diagrams illustrating an example of change based on a moving direction of parameters used to calculate the safety factor ratio in the second holding unit 200B. FIG. 17A is a diagram illustrating the second holding unit 200B carrying an object O in the moving direction DRa. FIG. 17B is a diagram illustrating the second holding unit 200B carrying an object O in the moving direction DRb.

A force mg based on the gravitational acceleration g is applied to the center of gravity G of the object O in FIGS. 17A and 17B downward in the vertical direction. An inertial force is applied in the opposite directions of the moving directions DRa and DRb. At this time, the force Fₘ applied to the center of gravity G of the object O is a combined force of the force mg based on the gravitational acceleration g and the inertial force. When the holding posture and the acceleration of the second holding unit 200B are the same in FIGS. 17A and 17B, the distance L f 2 in the moving direction in FIG. 17A is larger than the distance L_{f}2 in FIG. 17B.

As illustrated in FIGS. 17A and 17B, the distance L_{f}2 depends on the moving direction of the second holding unit 200B.

The magnitude relationship between the parameters based on the holding posture changes according to the shapes of the holding unit 200 and an object O, the position of the center of gravity G of the object O, and thus the embodiments described is not limited to the magnitude relationship.

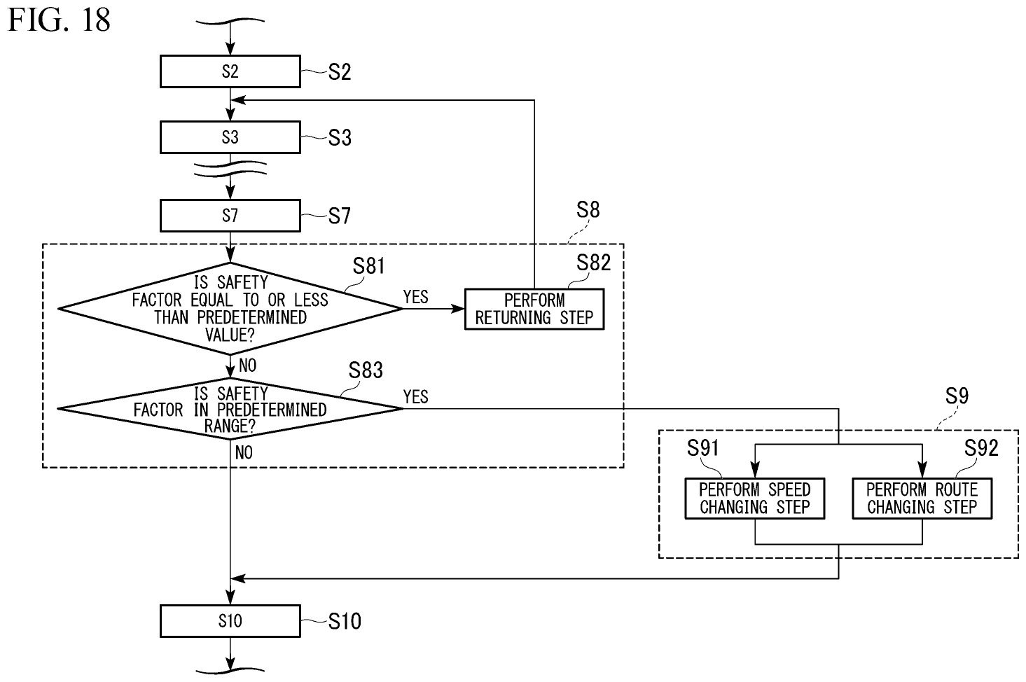

The operation changing unit 72 compares the planned safety factor calculated by the calculation method and the detected safety factor and corrects the carrying operation plan according to necessity. FIG. 18 is a flowchart illustrating an operation flow of a carrying operation plan determining step and a carrying operation plan correcting step according to the embodiment. An example of process details in Step S8 (the carrying operation plan determining step) and Step S9 (the carrying operation plan correcting step) will be described below with reference to FIG. 18.

The control device 12 performs Step S81 (a return determining step). In Step S81, the operation changing unit 72 compares the planned safety factor and the detected safety factor and determines whether the detected safety factor is equal to or less than the planned safety factor by a predetermined value.

For example, when the detected safety factor is equal to or less than the planned safety factor by a predetermined value and stable carrying cannot be realized even by changing the speed, the acceleration, an acceleration/deceleration pattern, an acceleration/deceleration section pattern, and a carrying route (transit points) of the holding unit 200, the operation changing unit 72 performs Step S82 (a returning step). In Step S82, the operation changing unit 72 returns the object O held by the holding unit 200 to the source container V1. Then, the operation flow returns to Step S3 and the operation changing unit 72 corrects the carrying operation plan such that the object O is held again. Since the safety factor ratio depends on the holding posture of the holding unit 200, it is possible to realize safety carrying by holding the object O again and changing the holding posture.

When the detected safety factor is not equal to or less than the planned safety factor by a predetermined value, the control device 12 performs Step S83 (an operation change determining step). In Step S83, the operation changing unit 72 determines whether the detected safety factor is in a predetermined range from the planned safety factor. This determination is to determine whether the carrying operation plan is to be corrected in order to stably carry the object O. When it is determined that the carrying operation plan is not to be corrected, the carrying operation plan is not corrected and the operation flow proceeds to Step S10.

When it is determined in Step S83 that the detected safety factor is in the predetermined range from the planned safety factor, that is, when it is determined that the carrying operation plan is to be corrected, the control device 12 performs Step S91 (a speed changing step) or Step S92 (a route changing step).

In Step S91, the operation changing unit 72 changes the speed, the acceleration, the acceleration/deceleration pattern, or the acceleration/deceleration section pattern of the holding unit 200. For example, when the detected safety factor is lower than the planned safety factor and there is a likelihood that the object O will drop from the holding unit 200 during carrying of the object, the acceleration is decreased. By decreasing the acceleration of the holding unit 200 carrying the object O, the force Fₘ applied to the object O can be decreased and dropping of the object O from the holding unit 200 can be curbed.

The operation changing unit 72 may perform Step S92 and change the carrying route (transit points). Since the safety factor ratio depends on the moving direction of the holding unit 200, it is possible to realize stable carrying by changing the carrying route (transit points) of the holding unit 200 carrying the object O.

In Step S91 and Step S92, the operation changing unit 72 may change one of the speed, the acceleration, the acceleration/deceleration pattern, the acceleration/deceleration section pattern, and the carrying route (transit points) of the holding unit 200 or may change two or more thereof.

When the detected safety factor is higher than the planned safety factor, the holding unit 200 carries the object O more stably than in the carrying operation plan. At this time, the operation changing unit 72 may correct the carrying operation plan to increase the speed or the acceleration of the holding unit 200.

When the carrying operation plan is corrected on the basis of the safety factor ratio, the control device 12 corrects the carrying operation plan within the range of the operation control information 42.

In this way, the control device 12 compares the planned safety factor and the detected safety factor, determines whether the carrying operation plan is to be corrected, and corrects the carrying operation plan within the range of the operation control information 42 when the carrying operation plan is to be corrected.

According to the handling system 1 at least one embodiment described above, it is possible to stably hold and carry an object O. The control device 12 of the handling system 1 acquires holding postures of the holding unit 200 and the object O while carrying the object and calculates the safety factor ratio on the basis of the acquired holding postures.

Even when the holding unit 200 carries the object O with a holding posture other than the carrying operation plan, it is possible to stably carry the object O by comparing the safety factor ratio (the planned safety factor) before the holding posture is acquired and the safety factor ratio (the detected safety factor) after the holding posture is acquired and correcting the carrying operation plan. When the detected safety factor is higher than the planned safety factor and the object O is stably held, it is possible to correct the carrying operation plan and to stably and efficiently carry the object O.

In the embodiment, the handling device 10 includes the first handling device 10A and the second handling device 10B. The handling device 10 may further include a handling device holding an object O using another holding method.

According to at least one of the aforementioned embodiments, since the safety factor ratio is calculated on the basis of the acquired holding posture and the carrying operation plan is corrected on the basis of the calculated safety factor ratio, it is possible to more stably carry an object.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover the forms and modifications that fall within the scope and spirit of the inventions.

What is claimed is:

1. A handling system comprising:
a holding unit configured to hold an object;
a holding state sensor attached to the holding unit and configured to detect a holding state in which the holding unit holds the object;
a detection unit configured to detect the object and a holding posture in which the holding unit holds the object; and
a control device configured to control an operation of the holding unit,
wherein the control device performs:
generating a carrying operation plan for allowing the holding unit to carry the object;
calculating a safety factor indicating stability of a state in which the holding unit holds the object on the basis of the holding state, the holding posture, and the carrying operation plan;
determining whether the carrying operation plan is to be changed on the basis of the safety factor; and
changing the carrying operation plan on the basis of the safety factor when it is determined that the carrying operation plan is to be changed.

2. The handling system according to claim 1,
wherein the control device changes a transit point of the holding unit in the carrying operation plan on the basis of the safety factor.

3. The handling system according to claim 1,
wherein the control device changes a speed or acceleration of the holding unit in the carrying operation plan on the basis of the safety factor.

4. The handling system according to claim 3,
wherein the control device changes the carrying operation plan in a limit range of operation control information for allowing the holding unit to carry the object.

5. The handling system according to claim 4,
wherein the operation control information includes a maximum carrying speed for each object, and
wherein the control device determines the speed of the holding unit in the carrying operation plan within a range of the maximum carrying speed.

6. The handling system according to claim 4,
wherein the operation control information includes a maximum carrying acceleration for each object, and
wherein the control device determines the acceleration of the holding unit in the carrying operation plan within a range of the maximum carrying acceleration.

7. The handling system according to claim 4,
wherein the operation control information includes a speed for each transit point at which the holding unit carries the object, and
wherein the control device determines the speed of the holding unit in the carrying operation plan within a range of the speed for each transit point.

8. The handling system according to claim 4,
wherein the operation control information includes an acceleration for each transit point at which the holding unit carries the object, and
wherein the control device determines the acceleration of the holding unit in the carrying operation plan within a range of the acceleration for each transit point.

9. A control device that controls a handling system including:
a holding unit configured to hold an object;
a holding state sensor attached to the holding unit and configured to detect a holding state in which the holding unit holds the object; and
a detection unit configured to detect the object and a holding posture in which the holding unit holds the object,
wherein the control device performs:
generating a carrying operation plan for allowing the holding unit to carry the object;
calculating a safety factor indicating stability of a state in which the holding unit holds the object on the basis of the holding state, the holding posture, and the carrying operation plan;
determining whether the carrying operation plan is to be changed on the basis of the safety factor; and
changing the carrying operation plan on the basis of the safety factor when it is determined that the carrying operation plan is to be changed.

10. The control device according to claim 9,
wherein a transit point of the holding unit in the carrying operation plan is changed on the basis of the safety factor.

11. The control device according to claim 9,
wherein a speed or acceleration of the holding unit in the carrying operation plan is changed on the basis of the safety factor.

12. The control device according to claim 11,
wherein the carrying operation plan is changed in a preset limit range of operation control information for allowing the holding unit to carry the object.

13. The control device according to claim 12,
wherein the operation control information includes a maximum carrying speed for each object, and
wherein the speed of the holding unit in the carrying operation plan is determined within a range of the maximum carrying speed.

14. The control device according to claim 12,
wherein the operation control information includes a maximum carrying acceleration for each object, and
wherein the acceleration of the holding unit in the carrying operation plan is determined within a range of the maximum carrying acceleration.

15. The control device according to claim 12,
wherein the operation control information includes a speed for each transit point at which the holding unit carries the object, and
wherein the speed of the holding unit in the carrying operation plan is determined within a range of the speed for each transit point.

16. The control device according to claim 12,
wherein the operation control information includes an acceleration for each transit point at which the holding unit carries the object, and
wherein the acceleration of the holding unit in the carrying operation plan is determined within a range of the acceleration for each transit point.

17. A handling method of carrying an object by a holding unit configured to hold the object, comprising, by a processor of a computer:
acquiring information of detecting a holding state and a holding posture in which the holding unit holds the object;
acquiring a carrying operation plan for allowing the holding unit to carry the object;
calculating a safety factor indicating stability of a state in which the holding unit holds the object on the basis of the holding state, the holding posture, and the carrying operation plan and correcting the carrying operation plan on the basis of the safety factor; and
causing the holding unit to carry the object on the basis of the corrected carrying operation plan.

18. A non-transitory computer-readable storage medium storing control program controlling a handling system including:
a holding unit configured to hold an object;
a holding state sensor attached to the holding unit and configured to detect a holding state in which the holding unit holds the object;
a detection unit configured to detect the object and a holding posture in which the holding unit holds the object; and
a control device configured to control an operation of the holding unit,
wherein the control program causes the control device to perform:
generating a carrying operation plan for allowing the holding unit to carry the object;
calculating a safety factor indicating stability of a state in which the holding unit holds the object on the basis of the holding state, the holding posture, and the carrying operation plan;
determining whether the carrying operation plan is to be changed on the basis of the safety factor; and
changing the carrying operation plan on the basis of the safety factor when it is determined that the carrying operation plan is to be changed.

19. The non-transitory computer-readable storage medium storing control program according to claim 18,
wherein the control device is caused to change a transit point of the holding unit in the carrying operation plan on the basis of the safety factor.

20. The non-transitory computer-readable storage medium storing control program according to claim 18,
wherein the control device is caused to change a speed or acceleration of the holding unit in the carrying operation plan on the basis of the safety factor.

21. The non-transitory computer-readable storage medium storing control program according to claim 20,
wherein the control device is caused to change the carrying operation plan in a limit range of operation control information for defining a basic operation for allowing the holding unit to carry the object.
